(19) United States
(12) Patent Application Publication
(10) Pub. No.: US 2014/0236956 A1
(43) Pub. Date: Aug. 21, 2014

(54) DIGITAL CONTENT SYSTEM, DIGITAL CONTENT DISPLAY METHOD, AND RECORDING MEDIUM HAVING RECORDED THEREON DIGITAL CONTENT DISPLAY PROGRAM

(71) Applicant: PAPELOOK INC., YOKOHAMA-SHI (JP)

(72) Inventors: Kazuhiro MATSUURA, Yokohama-shi (JP); Ichiro OZAWA, Yokohama-shi (JP)

(73) Assignee: PAPELOOK INC., YOKOHAMA-SHI (JP)

(21) Appl. No.: 14/181,235

(22) Filed: Feb. 14, 2014

(30) Foreign Application Priority Data
Feb. 15, 2013 (JP) 2013-028424

(51) Int. Cl. G06F 17/30

(52) U.S. Cl. CPC G06F 17/3053
USPC 707/740

(57) ABSTRACT

A digital content display system includes a content acquisition unit which acquires a plurality of digital content belonging to the category of the received category identification number through a network, and an information transmission unit which transmits summary information of the plurality of acquired digital content and information for causing the software to display the summary information in a predetermined order to the display apparatus, and causes the display apparatus to display detailed information of a selected digital content according to selection information of digital content selected by the user from the summary information of the plurality of digital content

### BACKGROUND OF THE INVENTION

1. Field of the Invention

The invention relates to a digital content system, a digital content display method, and a recording medium having recorded thereon a digital content display program, and in particular, to a digital content system, a digital content display method, and a recording medium having recorded thereon a digital content display program which displays digital content on a display apparatus.

2. Background Art

In recent years, digital content, such as blogs, news media, electronic books, are in widespread use. When gathering information using the digital content, in the related art, information to be gathered is generally selected by a user of the digital content.

As means which is used when the user gathers information personally, there are various means including an electronic book or a CD-ROM with a dictionary having fixed storage capacity, an academic page on Internet, a blog, news media, an electronic book using PDF, ePUB, or the like, an index by a search engine, word-of-mouth communication by a social network, and the like. In these, in addition to a method which displays a simple stock of information, there is a method which transmits information determined to be useful by a person who primarily reads information, called human filtering, or the like.

However, when the user gathers information personally, while it is easy to directly gather necessary information (referred to as primary information), it is difficult to gather information (referred to as secondary information, and for example, if the primary information is the name of an actress, the secondary information includes the name of a television program or the name of a magazine in which the actress appears, or the name of an actress having the same target demographic as the actress) associated with the primary information.

For this reason, a method, called collaborative filtering, in which, when a user action is taken in a certain site focusing on an electronic commerce (EC) site, different information in the site is recommended according to the user action has begun to be in widespread use.

Japanese Unexamined Patent Application Publication No. 2012-164042 discloses a technique which generates and provides recommendation information relating to a book with the details of interest to each system user. Specifically, Japanese Unexamined Patent Application Publication No. 2012-164042 describes a system including an information holding unit which holds user information, book names of book information, classification information, book identification information, and user interest information in association with the book names for all system users, and a recommendation generation unit which refers to the respective pieces of information held by the information holding unit with the classification information and the book identification information as a key to extract user information, the book name represented by book information, and user interest information for all system users, and to aggregate the user information, the book name represented by the book information, and the user interest information in a first table, and when the user interest information in the first table represents a favorite book of a system user, generates recommended book information including the book names in the first table excluding the names of the books owned by the system user.

Japanese Unexamined Patent Application Publication No. 2008-282098 discloses a technique which determines a recommended commodity in a combined manner from multiple viewpoints using the association from a different viewpoint from commodity correlation information based on a purchase history. Specifically, Japanese Unexamined Patent Application Publication No. 2008-282098 describes a system in which, when a user accesses a Web server, which operates a virtual shopping mall, with a user terminal, such as a personal computer, through Internet, clicks a commodity of interest in a Web page displayed on the browser of the user terminal, and purchases a commodity after viewing a commodity page representing information relating to the commodity, a recommendation server performs hybrid recommendation processing for determining a recommended commodity in a combined manner from two viewpoints using commodity correlation information storage means and personal commodity correlation information storage means.

The techniques disclosed in Japanese Unexamined Patent Application Publication No. 2012-164042 and Japanese Unexamined Patent Application Publication No. 2008-282098 can offer the secondary information associated with the primary information and are superior to a method which directly offers the primary information. However, in the above-described techniques, in order to determine what kind of secondary information is offered to the user, it is necessary to analyze an immediate action (purchase, view, or the like) of the user for certain primary information. For this reason, since only secondary information associated with the primary information, for which the user takes an immediate action, there is a problem in that, if the user has no background knowledge about matters to be checked, it is not possible to offer appropriate secondary information. Furthermore, it is possible to offer only secondary information which is stored in the site.

### SUMMARY OF THE INVENTION

Accordingly, the invention has been accomplished in consideration of the above-described situation, and an object of the invention is to provide a digital content display system, a digital content display method, and a recording medium having recorded thereon a digital content display program capable of offering a plurality of digital content in an integrated manner, changing the relation of primary information and secondary information according to the action of the user, and even if the user has no background knowledge about matters to be checked, acquiring and recommending appropriate secondary information outside the system.

According to an aspect of the invention, there is provided a digital content display system which displays digital content on a display apparatus of a user, the digital content display system including a distribution unit which distributes software causing the display apparatus to display digital content in one of a plurality of categories and allowing the user to select a predetermined category or a predetermined digital content among a plurality of categories of digital content, a category accepting unit which receives the category identification number of the selected category based on the software, a content acquisition unit which acquires a plurality of digital content belonging to the category of the received category identification number through a network, an information transmission unit which transmits summary information of the plurality of acquired digital content and information for causing the software to display the summary information in a predetermined order to the display apparatus, and causes the display apparatus to display detailed information of a selected digital content according to selection information of digital content selected by the user from the summary information of the plurality of digital content, and an update processing unit which acquires viewing information representing a viewing condition of the user corresponding to at least one of the selected category, the transmitted summary information, and the transmitted detailed information, updates summary information of digital content to be displayed on the display apparatus in a predetermined order according to the viewing information, and transmits the updated summary information to the display apparatus.

The term “digital content” refers to a set of information including sentences, music, images, video, or databases expressed in the format of digital data, or combinations thereof. The term “digital content” may include software for reproducing digital content, electronic books, electronic magazines, blogs, or home pages, and the like.

The term “display apparatus” refers to an apparatus which has a function of displaying digital content. The display apparatus may be at least one of a portable terminal, a client terminal, and a digital household appliance.

The term “category” refers to the type of digital content. Specifically, the term “category” may refer to the file format of digital content, such as sound or an image, or the type of electronic book, such as a detective story or essay, or the name of an electronic magazine.

The term “software” refers to a program which performs some kind of processing on a terminal, such as a computer. The term “software” may refer to a program which displays digital content classified by category on the display apparatus.

The term “distribution unit” refers to a unit which distributes software. A unit which distributes software to a terminal, which transmits a download request, may be used.

The term “category identification number” refers to an identification number which identifies a category. An ID allocated to each category may be used.

The term “category accepting unit” refers to a unit which receives a category selected by the user. The term “category accepting unit” may refer to a unit which receives the category identification number and discriminates the selected category.

The term “content acquisition unit” refers to a unit which acquires digital content selected by the user. A unit which acquires digital content associated with a category selected by the user from a different system through a network may be used.

The term “selection information” represents summary information of digital content selected by the user.

The term “information transmission unit” refers to a unit which causes the display apparatus to display information relating to digital content in a predetermined order. A unit which transmits information so as to be arranged in a time-series order of update date and time if digital content is updated may be used.

The term “summary information” represents the summary of digital content. The term “summary information” may indicate the title of digital content or a top page screen. For example, in a case of summary information of a blog, the summary information may indicate update date and time, an image, a title, or the first row of the details.

The term “detailed information” refers to information relating to the details of digital content. For example, if digital content is a blog, detailed information may indicate an article of the blog.

The term “viewing information” represents the viewing conditions of the user for a specific digital content. A viewing condition may indicate the viewing time, the number of views, or the like of the user. When a commodity relating to digital content is purchased, a purchase history may become viewing information. The viewing information may include information of digital content linked by the user, information of a shared blog, or the like.

The term “update processing unit” refers to a unit which transmits updated information to the display apparatus. The update processing unit may be a unit which transmits summary information of updated information such that the summary information is displayed in time series.

The digital content display system may further include a favorite management unit which displays digital content with a favorite tag attached by the user from the displayed digital content even after update processing.

The term “favorite management unit” refers to a unit which controls digital content displayed on the display apparatus after the update processing is performed by the update processing unit. The favorite management unit may be a unit which creates a page for favorite display and causes the display apparatus to display a list of digital content with a favorite tag attached.

The term “favorite tag” refers to incidental information which is attached to digital content by the user. A favorite tag may be a favorite tag which is managed on the display apparatus or may be a favorite tag which is received and managed on the digital content display system side.

The digital content display system may further include a preference analysis unit which analyzes user preference according to a viewing condition of the user for at least one of the category, the summary information, and the detailed information.

The term “preference analysis unit” refers to a unit which analyzes user preference. The preference analysis unit may be a unit which analyzes user preference based on viewing information of the user for digital content. For example, the preference analysis unit may analyze that, when the user views detailed information, the degree of preference about the information is high compared to when the user views only summary information. The preference analysis unit may be a unit which analyzes user preference with at least one of the viewing time, the number of views, and the purchase history of the user as information relating to a viewing condition.

The content acquisition unit may be a unit which selects digital content transmitted to the display apparatus from a plurality of digital content associated with the category based on an initial value of a score representing user preference of the digital content.

The term “initial value” refers to a value which, if the user selects a category for digital content for the first time, is given according to the selected category. The digital content may be given an initial value for each corresponding category. For example, a case where a certain digital content A has a strong relation with a category A, has little relation with a category B, and has no relation with a category C will be described. In this case, the digital content A is given a different initial value according to the selected category. For example, if the user selects the category A for the first time, the digital content A is given 10 as the initial value. If the user selects the category B for the first time, the digital content A is given 5 as the initial value, and if the user selects the category C, 0 is given.

The update processing unit may be a unit which updates the score of the digital content based on the analysis result of the preference analysis unit, and when updating the summary information to be displayed in the predetermined order, updates and transmits summary information of digital content, for which the updated score exceeds a predetermined threshold value.

The digital content display system may further include a user identification number allocation unit which allocates a unique user identification number to each user when distributing the software, and a score recording unit which records the updated score for each user identification number, in which the content acquisition unit may treat a score recorded in the score recording unit as the initial value of the score of the digital content.

The term “user identification number allocation unit” refers to a unit which allocates a unique number to each user. If the user has a plurality of display apparatuses, a single user identification number may be allocated to the same user, or different user identification numbers may be allocated to the respective display apparatuses.

The term “score recording unit” refers to a unit which records the score of digital content for each user identification number.

According to another aspect of the invention, there is provided a digital content display method which displays digital content on a display apparatus of a user, the digital content display method causing a computer to implement a step of distributing software causing the display apparatus to display digital content in one of a plurality of categories and allowing the user to select a predetermined category or a predetermined digital content among a plurality of categories of digital content, a step of receiving the category identification number of the selected category based on the software, a step of acquiring a plurality of digital content belonging to the category of the received category identification number through a network, a step of transmitting summary information of the plurality of acquired digital content and information for causing the software to display the summary information in a predetermined order to the display apparatus, and causing the display apparatus to display detailed information of a selected digital content according to selection information of digital content selected by the user from the summary information of the plurality of digital content, and a step of acquiring viewing information representing a viewing condition of the user corresponding to at least one of the selected category, the transmitted summary information, and the transmitted detailed information, updating summary information of digital content to be displayed on the display apparatus in a predetermined order, and transmitting the updated summary information to the display apparatus.

According to still another aspect of the invention, there is provided a recording medium having recorded thereon a digital content display program, which displays digital content on a display apparatus of a user, the digital content display program causing a computer to implement a function of distributing software causing the display apparatus to display digital content in one of a plurality of categories and allowing the user to select a predetermined category or a predetermined digital content among a plurality of categories of digital content, a function of receiving the category identification number of the selected category based on the software, a function of acquiring a plurality of digital content belonging to the category of the received category identification number through a network, a function of transmitting summary information of the plurality of acquired digital content and information for causing the software to display the summary information in a predetermined order to the display apparatus, and causing the display apparatus to display detailed information of a selected digital content according to selection information of digital content selected by the user from the summary information of the plurality of digital content, and a function of acquiring viewing information representing a viewing condition of the user corresponding to at least one of the selected category, the transmitted summary information, and the transmitted detailed information, updating summary information of digital content to be displayed on the display apparatus in a predetermined order, and transmitting the updated summary information to the display apparatus.

The digital content display system according to the aspect of the invention includes the content acquisition unit which acquires a plurality of digital content belonging to the category of the received category identification number through a network, the information transmission unit which transmits summary information of the plurality of acquired digital content and information for causing the software to display the summary information in a predetermined order to the display apparatus, and causes the display apparatus to display detailed information of a selected digital content according to selection information of digital content selected by the user from the summary information of the plurality of digital content, and the update processing unit which acquires viewing information representing a viewing condition of the user corresponding to at least one of the selected category, the transmitted summary information, and the transmitted detailed information, updates summary information of digital content to be displayed on the display apparatus in a predetermined order according to the viewing information, and transmits the updated summary information to the display apparatus. Therefore, it becomes possible to offer a plurality of digital content in an integrated manner, to change the relation of primary information and secondary information according to the action of the user, and even if the user has no background knowledge about matters to be checked, to acquire and recommend appropriate secondary information outside the system.

The digital content display system according to the aspect of the invention further includes the preference analysis unit which analyzes user preference according to a viewing condition of the user for at least one of the category, the summary information, and the detailed information. Therefore, it becomes possible to prevent information of little interest to the user from being recommended, and even if the user has no background knowledge about secondary information to acquire, it becomes possible to acquire appropriate information.

The digital content display system includes the favorite management unit which displays digital content with a favorite tag attached by the user from the displayed digital content after update processing. Therefore, it becomes possible to secure favorite information of the user at a location where all pieces of information can be immediately viewed even after the update processing.

The content acquisition unit is a unit which selects digital content transmitted to the display apparatus from a plurality of digital content associated with the category based on an initial value of a score representing user preference of the digital content. Therefore, even if the user has no background knowledge about secondary information to acquire, it becomes possible to acquire appropriate information.

The update processing unit is a unit which updates the score of the digital content based on the analysis result of the preference analysis unit, and when updating the summary information to be displayed in the predetermined order, updates and transmits summary information of digital content, for which the updated score exceeds a predetermined threshold value. Therefore, it becomes possible to change the relation of primary information and secondary information according to the action of the user, and to recommend secondary information, for which the degree of preference of the user is high.

The digital content display system according to the aspect of the invention further includes a user identification number allocation unit which allocates a unique user identification number to each user when distributing the software, and a score recording unit which records the updated score for each user identification number, and the content acquisition unit is a unit which treats a score recorded in the score recording unit as the initial value of the score of the digital content. Therefore, it becomes possible to change secondary information to be recommended between the users.

The preference analysis unit is a unit which analyzes user preference with at least one of the viewing time, the number of views, and the purchase history of the user as information relating to a viewing condition. Therefore, it becomes possible to analyze preference according to the action of the user, and to recommend more appropriate information.

### BRIEF DESCRIPTION OF THE DRAWINGS

FIG. 1 is a block diagram of a digital content display system and an external system according to a first embodiment of the invention.

FIG. 2 is a flowchart showing processing of the digital content display system according to the first embodiment of the invention.

FIGS. 3A to 3C are image diagrams of a screen which is displayed on a display apparatus by software according to the invention.

FIGS. 4A to 4C are image diagrams of a screen which is displayed on a display apparatus by software according to the invention.

FIG. 5 is a flowchart showing recommendation processing of the digital content display system according to the first embodiment of the invention.

FIG. 6 is a schematic view showing the correspondence relationship between a category and a source in a database according to the first embodiment of the invention.

FIG. 7 is a schematic view showing the correspondence relationship between a category and a source in a database according to the first embodiment of the invention.

FIG. 8 is a schematic view showing the correspondence relationship between a category and a source in a database according to the first embodiment of the invention.

FIG. 9 is a block diagram of a digital content display system and an external system according to another embodiment of the invention.

FIG. 10 is a flowchart showing processing of a display apparatus according to another embodiment of the invention.

FIG. 11 is a flowchart showing processing of the digital content display system according to the first embodiment of the invention.

FIG. 12 is a chart showing a processing flow of a digital content display system according to another embodiment of the invention.

### DETAILED DESCRIPTION OF THE INVENTION

### First Embodiment

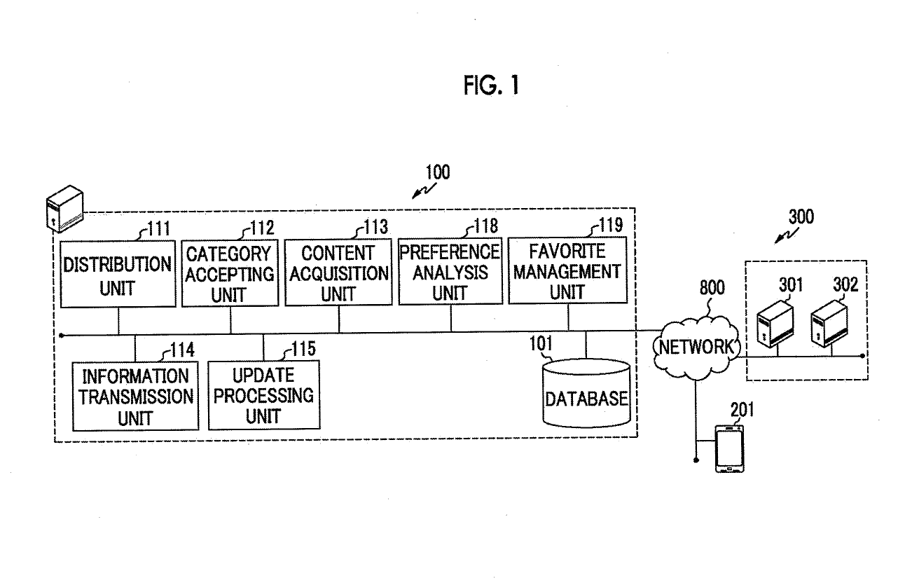

Hereinafter, a first embodiment of the invention will be described referring to FIGS. 1 to 8.

A digital content display system 100 of this embodiment includes a distribution unit 111 which distributes software causing a display apparatus 201 to display digital content in one of a plurality of categories and allowing the user to select a predetermined category or a predetermined digital content among a plurality of categories of digital content, a category accepting unit 112 which receives the category identification number of the selected category based on the software, a content acquisition unit 113 which acquires a plurality of digital content belonging to the category of the received category identification number through a network 800, an information transmission unit 114 which transmits summary information of the plurality of acquired digital content and information for causing the software to display the summary information in a predetermined order to the display apparatus 201, and causes the display apparatus 201 to display detailed information of a selected digital content according to selection information of digital content selected by the user from the summary information of the plurality of digital content, and an update processing unit 115 which acquires viewing information representing a viewing condition of the user corresponding to at least one of the selected category, the transmitted summary information, and the transmitted detailed information, updates summary information of digital content to be displayed on the display apparatus 201 in a predetermined order according to the viewing information, and transmits the updated summary information to the display apparatus 201.

In this embodiment, the digital content display system 100 may further include a preference analysis unit 118 which analyzes user preference according to a viewing condition of the user for at least one of the category, the summary information, and the detailed information.

In this embodiment, the digital content display system 100 may further include a favorite management unit 119 which displays digital content with a favorite tag attached by the user from the displayed digital content after update processing.

The digital content display system 100 includes a computer or a server, and operates as various functional units when a program recorded in a RAM, a hard disk, or the like is executed based on various inputs. The program may be stored in a storage medium, such as a CD-ROM, or may be distributed through the network 800, such as Internet, and installed on a computer.

In this embodiment, the digital content display system 100 recommends and offers digital content, such as commodity information on a blog, a home page, or an electronic commerce (EC) site 301 conforming to user preference. A digital content refers to a set of information including sentences, music, images, video, or the database 101 expressed in the format of digital data, or combinations thereof. A digital content may include software for reproducing digital content, electronic books, electronic magazines, blogs, or home pages, and the like.

Software is a program which performs some kind of processing on a terminal, such as a computer. The software is used to display digital content classified by category on the display apparatus 201.

The display apparatus 201 refers to an apparatus which has a function of displaying a screen. Specifically, the display apparatus 201 means a client terminal, such as a PC or a tablet, a portable terminal, such as a smartphone, a PDA, or a portable terminal, a television with a set-top box connected thereto, an Internet accessible television, or other digital appliances.

A category is the type of digital content. Specifically, a category may refer to the file format of digital content, such as sound or an image, or the type of electronic book, such as detective story or essay, or the name of an electronic magazine. A category is managed by a category identification number which is an ID allocated to each category.

FIG. 1 is a block diagram showing the configuration of the digital content display system 100 in this embodiment.

The digital content display system 100 includes a distribution unit 111, a category accepting unit 112, a content acquisition unit 113, an information transmission unit 114, an update processing unit 115, a preference analysis unit 118, a favorite management unit 119, and a database 101. The digital content display system 100 cooperates with a display apparatus 201 and other systems, that is, an EC site 301 and a WEB site 302 as an external system 300 through a network 800.

The WEB site 302 refers to a site, such as a blog or a home page, which manages digital content.

The distribution unit 111 distributes software. The software may be distributed to a terminal which transmits a download request.

The category accepting unit 112 receives a category selected by the user. The category accepting unit 112 may be a unit which receives a category identification number and discriminates the selected category.

The content acquisition unit 113 acquires digital content selected by the user. The content acquisition unit 113 may be a unit which acquires digital content associated with a category selected by the user from a different system through the network 800. The content acquisition unit 113 may be a unit which selects digital content to be transmitted to the display apparatus 201 among a plurality of digital content associated with the category based on an initial value of a score representing user preference of the digital content.

The initial value refers to a value which, if the user selects a category for digital content for the first time, is given according to the selected category. The digital content may be given an initial value for each corresponding category. For example, a case where a certain digital content A has a strong relation with a category A, has little relation with a category B, and has no relation with a category C will be described. In this case, the digital content A is given a different initial value according to the selected category. For example, if the user selects the category A for the first time, the digital content A is given 10 as the initial value. If the user selects the category B for the first time, the digital content A is given 5 as the initial value, and if the user selects the category C, 0 is given.

The information transmission unit 114 transmits summary information to the display apparatus 201 and causes the display apparatus 201 to display the detailed information of the summary information selected by the user in a predetermined order. For example, the predetermined order may be an order of update date and time, and the summary information may be transmitted so as to be arranged in time series of update date and time if digital content is updated.

The update processing unit 115 transmits the summary information of the updated information such that the summary information is displayed in a predetermined order. The update processing unit 115 may be a unit which updates the score of the digital content based on the analysis result of the preference analysis unit 118, and when updating the summary information to be displayed in the predetermined order, updates and transmits summary information of digital content, for which the updated score exceeds a predetermined threshold value.

The preference analysis unit 118 analyzes user preference. The preference analysis unit 118 may analyze user preference based on the viewing information of the user for digital content. For example, the preference analysis unit 118 may analyze that, when the user views detailed information, the degree of preference about the information is high compared to when the user views only summary information. The preference analysis unit 118 may be a unit which analyzes user preference with at least one of the viewing time, the number of views, and the purchase history of the user as information relating to a viewing condition.

The favorite management unit 119 refers to a unit which controls the digital content to be displayed on the display apparatus 201 after the update processing is performed by the update processing unit 115. The favorite management unit 119 may be a unit which creates a page for favorite display and causes the display apparatus 201 to display a list of digital content with a favorite tag attached.

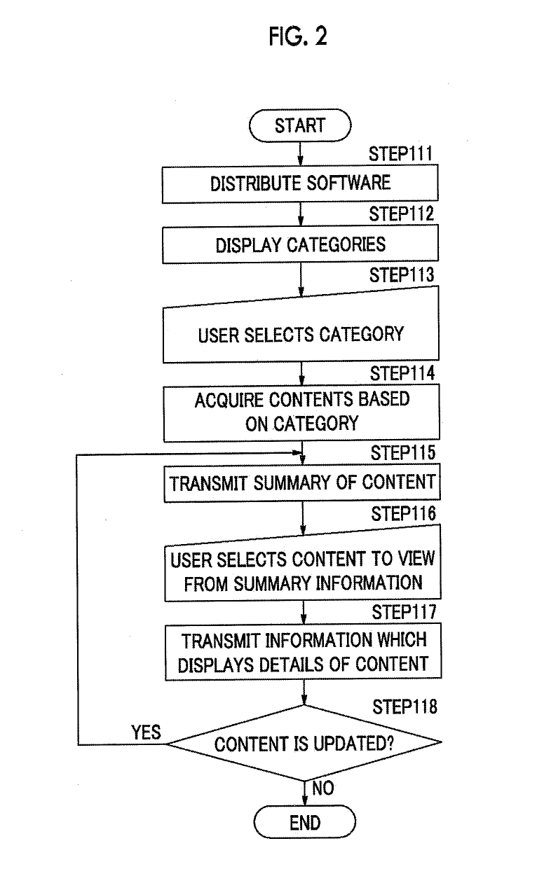

Next, a processing flow when the user accesses the digital content display system 100 in this embodiment for the first time will be described referring to FIG. 2.

First, the distribution unit 111 distributes software to the display apparatus 201 which gives a connection request to the digital content display system 100 (STEP111). The software operates on the display apparatus 201, and has a function of causing the display apparatus 201 to display digital content or a function of gathering information relating to the selected digital content and transmitting information to the digital content display system 100.

The software distributed to the display apparatus 201 displays categories of digital content (STEP112).

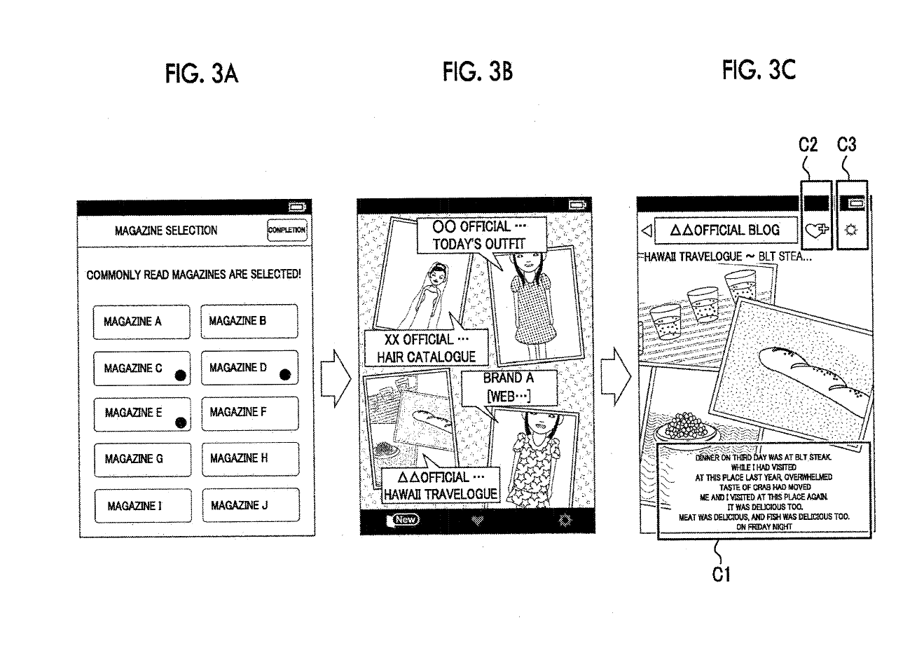

FIGS. 3A to 3C are image diagrams showing a screen which is displayed on the display apparatus 201 by the software. FIG. 3A shows a category selection screen, FIG. 3B shows a summary information display screen, and FIG. 3C shows a detailed information display screen. In this example, the digital content display system 100 treats the name of a magazine as a category. In this case, for example, the magazine name may be managed on the database 101 in association with a magazine model or a brand of a featured clothing or accessory. A magazine model or a brand refers to a source. A source refers to the details of information covered in a magazine. For example, if a magazine is a tourist information paper or the like, the source is the name of a tourist site or a specialty, and if a magazine is a magazine relating to car, the source is a car model, a manufacturer, or the like.

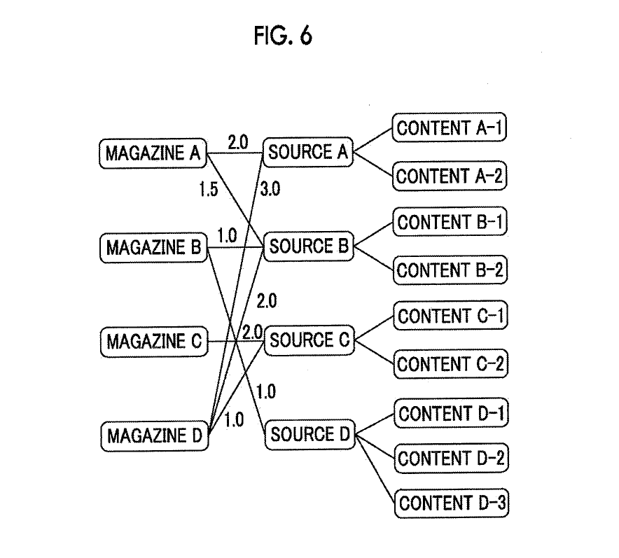

A source (in this case, a magazine model, a brand, or the like) is recorded in association with a home page which treats the source, a blog of a magazine model, or the like. In the database 101, each time a home page or a blog is updated, the source may be managed in association with the updated home page or blog as well. In the database 101, the degree of preference analyzed by the preference analysis unit 118 described below may be registered in conjunction. The details of the association will be described below referring to FIG. 6.

The continuation of the processing in FIG. 2 will be described. The user selects a favorite magazine or an interesting magazine from the magazine names (categories) displayed on the display apparatus 201 (STEP113). The user may select a plurality of magazine names. A magazine name selected by the user is accepted as a category identification number by the category accepting unit 112.

The content acquisition unit 113 inquires the database 101 about a home page or a blog of a magazine model or a brand associated with the accepted category identification number. The content acquisition unit 113 confirms update information on the database 101 and then acquires the digital content of the home page, the blog, or the like from the WEB site 302 through the network 800 (STEP114). The contents to be acquired at this time are selected by recommendation processing described below.

The information transmission unit 114 creates summary information from the acquired digital content. The summary information represents the summary of digital content. The summary information may indicate the title of digital content or a top page screen. For example, in a case of summary information of a blog, as shown in FIG. 3B, the summary information may indicate update date and time, an image, a title, or the first row of the details.

Returning to FIG. 2, the continuation of the processing will be described. The information transmission unit 114 transmits the created summary information to the display apparatus 201 such that the summary information is displayed in a predetermined order. In this embodiment, the summary information is transmitted to the display apparatus 201 so as to be displayed in time series with the update date and time of the digital content (STEP115). The created summary information at this time is managed in association with the original digital content on the database 101.

The user selects the summary information of digital content to view from the summary information shown in FIG. 3B (STEP116). The summary information selected by the user is transmitted to the digital content display system 100 as selection information, and the information transmission unit 114 transmits the details of the digital content associated with the summary information to the display apparatus 201 as detailed information based on the selection information (STEP117).

FIG. 3C shows detailed information displayed on the display apparatus 201. In FIG. 3C, reference numeral C2 denotes a like button. The like button has a function of bookmarking a favorite digital content of the user. A favorite tag is attached to digital content, for which the like button is pressed, by the favorite management unit 119. A favorite tag refers to incidental information which is attached to digital content by the user. A favorite tag is managed on the display apparatus 201. A favorite tag may be received and managed on the digital content display system 100 side.

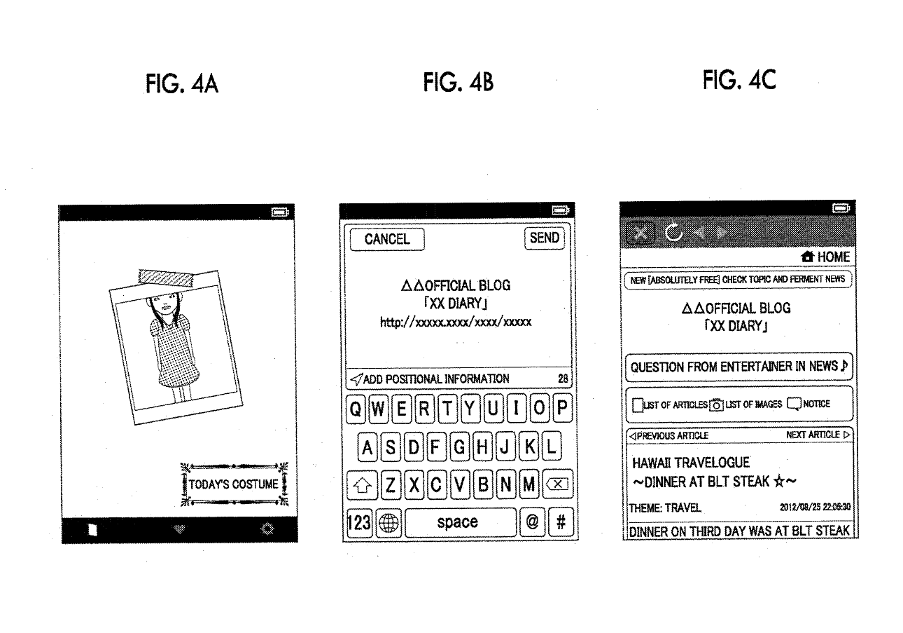

In FIG. 3B, reference numeral B1 denotes a link to a bookmark which is managed by the favorite management unit 119. If B1 is pressed, the screen is transited to a screen shown in FIG. 4A,

In C1 of FIG. 3C, a link to a screen which displays detailed information of the WEB site 302 is established. If the user presses C1 of FIG. 3C, a detailed screen shown in FIG. 4C can be displayed.

Reference numeral C3 of FIG. 3C denotes a button for transition to a comment send screen. If the user presses C3 of FIG. 3C, the comment send screen shown in FIG. 4B can be displayed.

Returning to FIG. 2, the continuation of the flow will be described. The update processing unit 115 monitors the database 101, and if digital content is updated (STEP118: YES), retransmits the summary information of the digital content to the display apparatus 201 such that the summary information is displayed in time series in conformity of the update date and time of the updated digital content.

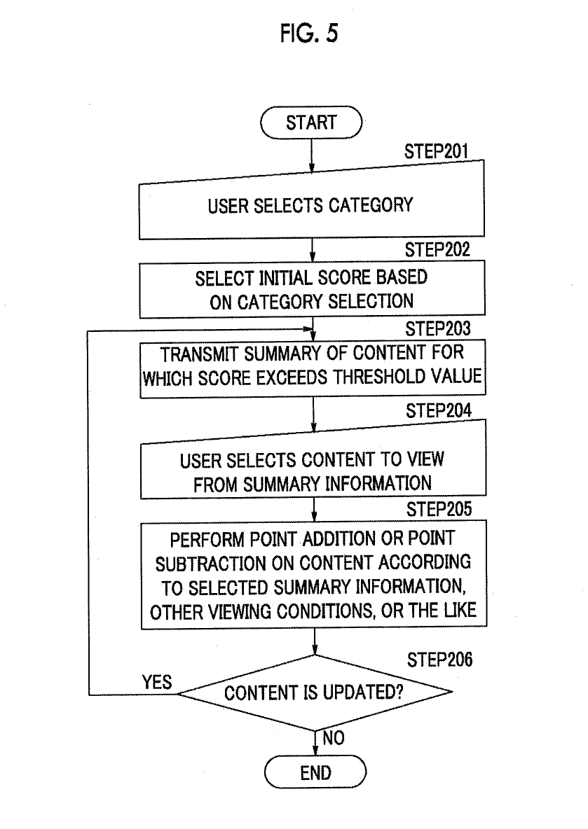

FIG. 5 is a chart showing a flow of recommendation processing of the digital content display system 100. The user selects a magazine name (category) from the magazine names displayed on the software (STEP201). The preference analysis unit 118 gives an initial value to each of the associated digital content on the database 101 according to the selected category (STEP202).

FIG. 6 is a diagram schematically showing a form in which a category is managed in association with summary information and detailed information on the database 101. On the database 101, magazine names as a category are associated with sources (magazine model, brand, or the like) and digital content. The relation between a magazine and a source is weighted. The initial value is given according to the degree of relation between a magazine and a source.

Specifically, for example, description will be provided assuming that a source A is a model 1, a source B is a brand 1, a source C is a brand 2, and a source D is a model 2. The model 1 is a model under exclusive contract with a magazine D. Since the magazine D and a magazine A have a special tie of friendship, the model 1 also appears in the magazine A. A model 2 is a model under exclusive contract with a magazine B. The brand 1 is a brand which is covered in the magazines A, B, and D, and the brand 2 is often covered in the magazines C and D.

If this relationship is established, the correspondence relationship between the magazines and the sources are weighted as shown in FIG. 6. First, since the model 1 (source A) has a correspondence relationship with the magazines A and D, and is a model under exclusive contract with the magazine D, the weighting of the correspondence relationship with the magazine D is high. Similarly, since the model 2 (source D) only appears in the magazine B, the model 2 has no correspondence relationship with other magazines. The brands 1 and 2 have a correspondence relationship with the magazines in which the brands 1 and 2 are published, and the higher the appearance frequency, the higher the weighting.

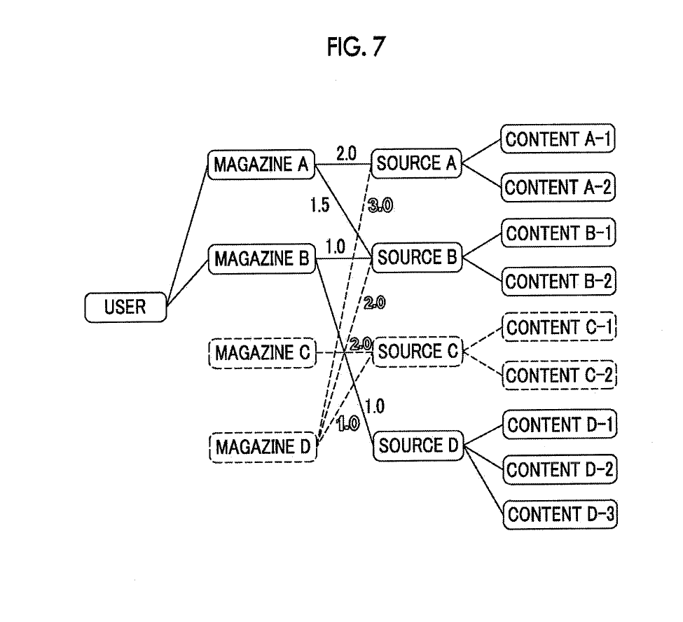

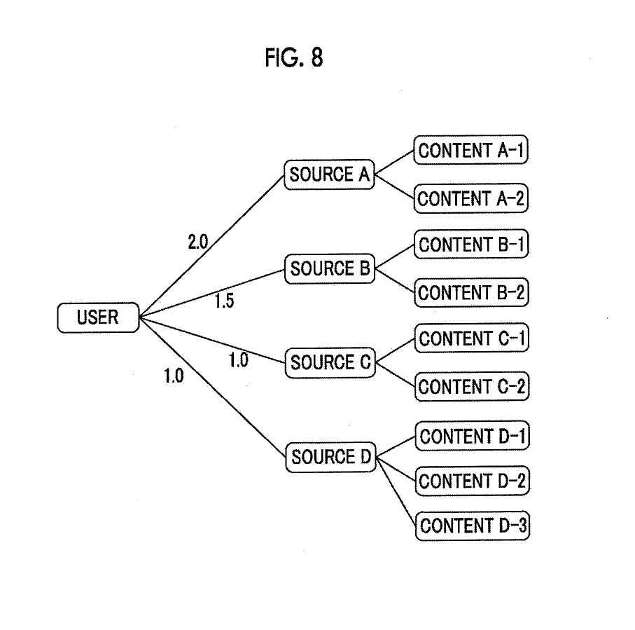

FIG. 7 shows a form in which the user selects the magazine A and the magazine B in STEP201 of FIG. 5. Since the sources A, B, and c are related to the magazine A and the magazine B, digital content A-1, A-2, B-1, B-2, D-1, D-2, and D-3 are acquired by the content acquisition unit 113. If the user selects a category for the first time, as shown in FIG. 8, the user is recorded so as to be directly related to the respective sources on the database 101.

Returning to FIG. 6, the continuation of the recommendation processing will be described. The preference analysis unit 118 performs point addition/point subtraction processing to the initial value according to the selected category and the weighting of the source associated with the category. Specifically, points are added to the sources A, B, and C which are related to the magazine A and the magazine B as the category selected by the user. In particular, the source A with a high weighting in the relationship with the magazine A is given points greater than the source B. Meanwhile, since the magazine C and the magazine D are not selected, the point addition processing is not performed to the source C which is only related to the magazine C.

The information transmission unit 114 transmits the summary information of digital content associated with a source, for which the score exceeds a predetermined threshold value, among the acquired digital content (STEP203). The user selects summary information to view from the summary information displayed on the display apparatus 201 (STEP204). If the summary information is selected, the preference analysis unit 118 performs point addition/point subtraction processing to a corresponding source according to the selected summary information (STEP205). The point addition/point subtraction processing may be performed according to all viewing conditions of the user as well as the selected summary information.

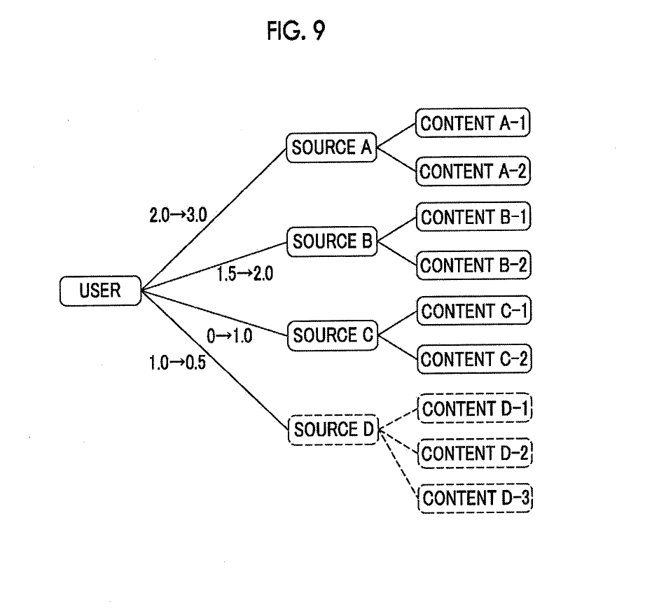

FIG. 9 is a diagram showing change in score when the user often reads the sources A and B and does not read the source D frequently. The preference analysis unit 118 changes a score according to the viewing information of the user for each source. The viewing information represents the viewing conditions of the user for a specific digital content. A viewing condition may indicate the viewing time, the number of views, or the like of the user. When a commodity relating to digital content is purchased, a purchase history may be viewing information. When the preference analysis unit 118 changes the score, digital content associated with a source (in FIG. 9, the source D), for which the score becomes equal to or smaller than the threshold value, are not distributed.

The change in score of a source may be made according to the degree of association of each source. For example, if the degree of association between the source B and the source C is high, the score of the source C increases with an increase in the score of the source B, and if the score exceeds the threshold value, the digital content associated with the source C are distributed.

Returning to FIG. 5, the continuation of the processing will be described. If digital content is updated (STEP206: YES), the update processing unit 115 retransmits the summary information of the digital content, for which the score exceeds the threshold value.

### Second Embodiment

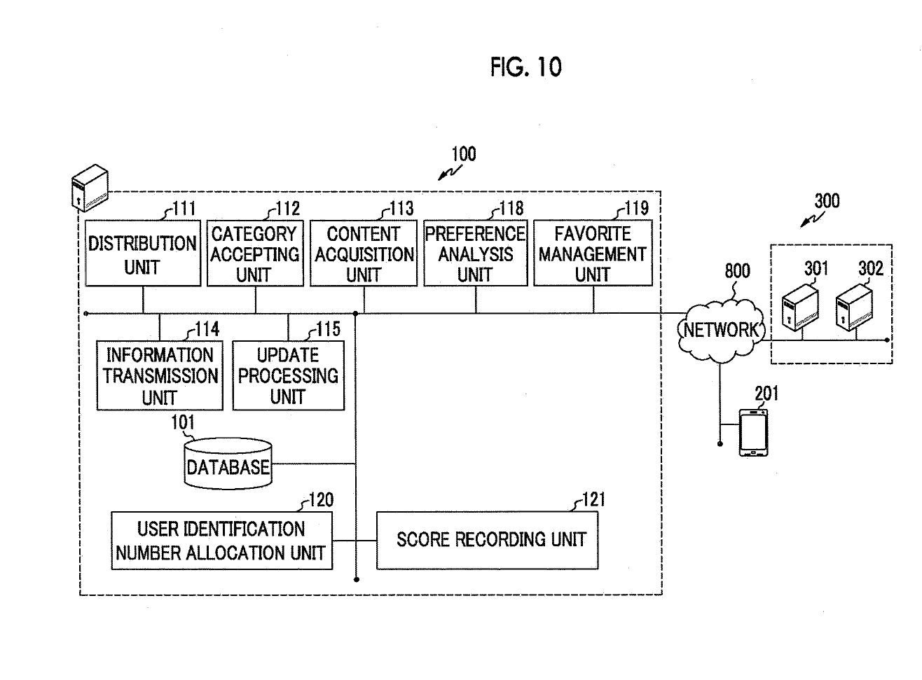

Hereinafter, another embodiment of the invention will be described referring to FIGS. 10 to 12.

A digital content display system 100 of this embodiment includes a distribution unit 111 which distributes software causing a display apparatus 201 to display digital content in one of a plurality of categories and allowing the user to select a predetermined category or a predetermined digital content among a plurality of categories of digital content, a category accepting unit 112 which receives the category identification number of the selected category based on the software, a content acquisition unit 113 which acquires a plurality of digital content belonging to the category of the received category identification number through a network 800, an information transmission unit 114 which transmits summary information of the plurality of acquired digital content and information for causing the software to display the summary information in a predetermined order to the display apparatus 201, and causes the display apparatus 201 to display detailed information of a selected digital content according to selection information of digital content selected by the user from the summary information of the plurality of digital content, and an update processing unit 115 which acquires viewing information representing a viewing condition of the user corresponding to at least one of the selected category, the transmitted summary information, and the transmitted detailed information, updates summary information of digital content to be displayed on the display apparatus 201 in a predetermined order according to the viewing information, and transmits the updated summary information to the display apparatus 201.

In this embodiment, the digital content display system 100 may further include a preference analysis unit 118 which analyzes user preference according to a viewing condition of the user for at least one of the category, the summary information, and the detailed information.

In this embodiment, the digital content display system 100 may further include a favorite management unit 119 which displays digital content with a favorite tag attached by the user from the displayed digital content after update processing.

The digital content display system 100 may further include a user identification number allocation unit 120 which allocates a unique user identification number to each user when distributing the software, and a score recording unit 121 which records the updated score for each user identification number. The content acquisition unit 113 may be a unit which treats a score recorded in the score recording unit 121 as the initial value of the score of the digital content.

FIG. 10 is a block diagram showing the configuration of a digital content display system 100 of this embodiment.

The digital content display system 100 includes a distribution unit 111, a category accepting unit 112, a content acquisition unit 113, an information transmission unit 114, an update processing unit 115, a preference analysis unit 118, a favorite management unit 119, a user identification number allocation unit 120, a score recording unit 121, and a database 101. The digital content display system 100 cooperates with a display apparatus 201 and other systems, that is, an EC site 301 and a WEB site 302 through a network 800.

The user identification number allocation unit 120 refers to a unit which allocates a unique number to each user. If the user has a plurality of display apparatuses 201, a single user identification number may be allocated to the same user, or different user identification numbers may be allocated to the respective display apparatuses 201.

The score recording unit 121 refers to a unit which records the score of digital content for each user identification number.

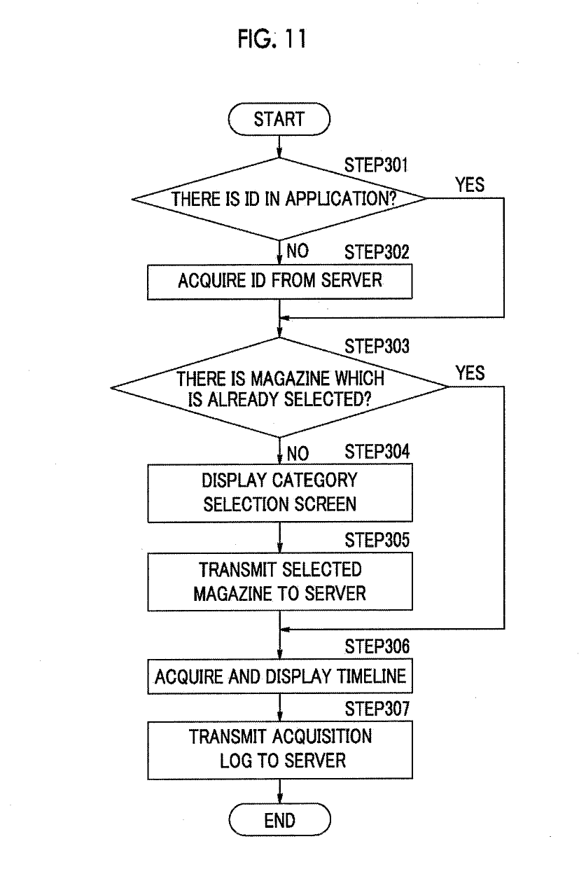

FIG. 11 is a flowchart showing processing of software which is installed on the display apparatus 201 in this embodiment. Software which is downloaded from the distribution unit 111 to the display apparatus 201 confirms whether or not there is the user identification number in the software upon activation (STEP301).

If there is no user identification number in the software (STEP301: NO), the software acquires the user identification number from the user identification number allocation unit 120 (STEP302).

The user identification number refers to information, such as a unique ID, for identifying the user. If the user identification number is acquired from the user identification number allocation unit 120, or if there is already the user identification number in the software (STEP301: YES), it is tested whether or not a category is already selected by the user (STEP303).

If a category is not selected (STEP303: NO), the software displays a category selection screen on the display apparatus 201 (STEP304). If the user selects a category, the category identification number of the selected category is transmitted to the category accepting unit 112 (STEP305).

Thereafter, the software displays the transmitted summary information (STEP306), acquires conditions, such as the viewing time, the number of views, and the like of the user as viewing information, and transmits the acquired viewing information to the preference analysis unit 118 (STEP307).

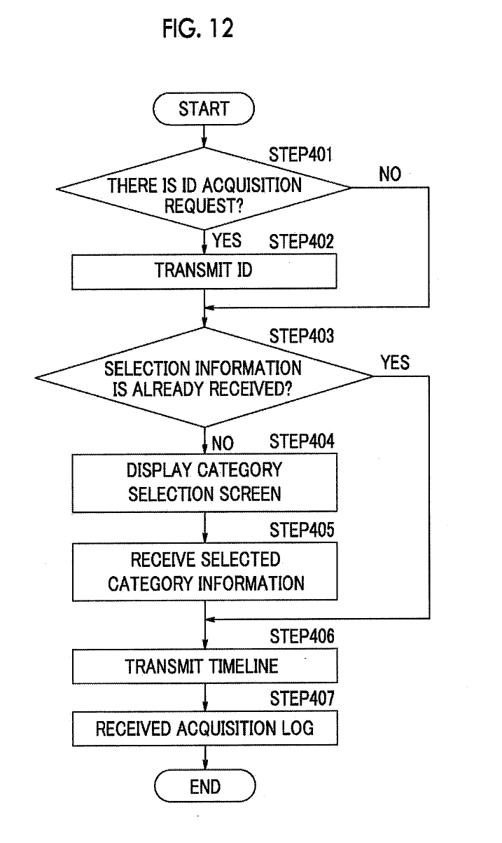

FIG. 12 is a chart showing a processing flow of the digital content display system 100 in another embodiment. If a request to acquire a user identification number from the software installed on the display apparatus 201 (STEP401: YES), the user identification number allocation unit 120 transmits the user identification number to the software (STEP402).

Next, it is confirmed whether or not the selection information is already received (STEP403), and if the selection information is not received (STEP403: NO), the digital content display system 100 transmits the category selection screen (STEP404). Thereafter, the digital content display system 100 receives the selected category as a category identification number (STEP405), transmits the summary information in time series based on the category identification number (STEP406), and receives the acquisition log of the viewing information of the user from the software (STEP407).

At this time, as in the first embodiment, the preference analysis unit 118 analyzes user preference from the viewing information and changes the score of a source corresponding to digital content. The change in score may be managed for each user identification number and recorded in the score recording unit 121 in terms of users.

Other configurations and functions are the same as those in the first embodiment.

### Other Embodiments

Although the embodiments of the invention have been described, the invention is not limited to the above-described embodiments, and various modifications and alterations may be made based on the technical spirit of the invention. For example, in the first and second embodiments of the invention, although a case where the update processing unit 115 performs push-type processing for monitoring the database 101, and if digital content is updated, giving notification of the updated digital content to the information transmission unit 114, the processing of the update processing unit 115 is not limited thereto, and for example, pull-type processing in which the display apparatus 201 performs polling in a constant period, and if polling is performed, the update processing unit 115 confirms the details of the update may be performed.

Although a case where the information transmission unit 114 and the update processing unit 115 transmit the summary information of the digital content to the display apparatus 201 such that the summary information is displayed in time series has been described, the invention is not limited thereto, and for example, the summary information of the digital content may be transmitted to the display apparatus 201 in a Japanese alphabetical order of the creators of the digital content.

The digital content display system 100 includes the content acquisition unit 113 which acquires a plurality of digital content belonging to the category of the received category identification number through the network 800, the information transmission unit 114 which transmits summary information of the plurality of acquired digital content and information for causing the software to display the summary information in a predetermined order to the display apparatus 201, and causes the display apparatus 201 to display detailed information of a selected digital content according to selection information of digital content selected by the user from the summary information of the plurality of digital content, and the update processing unit 115 which acquires viewing information representing a viewing condition of the user corresponding to at least one of the selected category, the transmitted summary information, and the transmitted detailed information, updates summary information of digital content to be displayed on the display apparatus 201 in a predetermined order according to the viewing information, and transmits the updated summary information to the display apparatus 201. Therefore, it becomes possible to offer a plurality of digital content in an integrated manner, to change the relation of primary information and secondary information according to the action of the user, and even if the user has no background knowledge about matter to be checked, to acquire and recommend appropriate secondary information outside the system.

The digital content display system 100 further includes the preference analysis unit 118 which analyzes user preference according to a viewing condition of the user for at least one of the category, the summary information, and the detailed information. Therefore, it becomes possible to prevent information of little interest to the user from being recommended, and even if the user has no background knowledge about secondary information to acquire, it becomes possible to acquire appropriate information.

The digital content display system 100 includes the favorite management unit 119 which displays digital content with a favorite tag attached by the user from the displayed digital content after update processing. Therefore, it becomes possible to secure favorite information of the user at a location where all pieces of information can be immediately viewed even after the update processing.

The content acquisition unit 113 is a unit which selects digital content transmitted to the display apparatus 201 from a plurality of digital content associated with the category based on an initial value of a score representing user preference of the digital content. Therefore, even if the user has no background knowledge about secondary information to acquire, it becomes possible to acquire appropriate information.

The update processing unit 115 is a unit which updates the score of the digital content based on the analysis result of the preference analysis unit 118, and when updating the summary information to be displayed in the predetermined order, updates and transmits summary information of digital content, for which the updated score exceeds a predetermined threshold value. Therefore, it becomes possible to change the relation of primary information and secondary information according to the action of the user, and to recommend secondary information, for which the degree of preference of the user is high.

The digital content display system 100 further includes a user identification number allocation unit 120 which allocates a unique user identification number to each user when distributing the software, and a score recording unit 121 which records the updated score for each user identification number, and the content acquisition unit 113 is a unit which treats a score recorded in the score recording unit 121 as the initial value of the score of the digital content. Therefore, it becomes possible to change secondary information to be recommended between the users.

The preference analysis unit 118 is a unit which analyzes user preference with at least one of the viewing time, the number of views, and the purchase history of the user as information relating to a viewing condition. Therefore, it becomes possible to analyze preference according to the action of the user, and to recommend more appropriate information.

1. A digital content display system which displays digital content on a display apparatus of a user, the digital content display system comprising:
a distribution unit which distributes software causing the display apparatus to display digital content in one of a plurality of categories and allowing the user to select a predetermined category or a predetermined digital content among a plurality of categories of digital content;
a category accepting unit which receives the category identification number of the selected category based on the software;
a content acquisition unit which acquires a plurality of digital content belonging to the category of the received category identification number through a network;
an information transmission unit which transmits summary information of the plurality of acquired digital content and information for causing the software to display the summary information in a predetermined order to the display apparatus, and causes the display apparatus to display detailed information of a selected digital content according to selection information of digital content selected by the user from the summary information of the plurality of digital content; and
an update processing unit which acquires viewing information representing a viewing condition of the user corresponding to at least one of the selected category, the transmitted summary information, and the transmitted detailed information, updates summary information of digital content to be displayed on the display apparatus in a predetermined order according to the viewing information, and transmits the updated summary information to the display apparatus.

2. The digital content display system according to claim 1,
wherein the display apparatus is at least one of a portable terminal, a client terminal, and a digital household appliance.

3. The digital content display system according to claim 1, further comprising:
a preference analysis unit which analyzes user preference according to a viewing condition of the user for at least one of the category, the summary information, and the detailed information.

4. The digital content display system according to claim 1, further comprising:
a favorite management unit which displays digital content with a favorite tag attached by the user from the displayed digital content after update processing.

5. The digital content display system according to claim 3,
wherein the content acquisition unit selects digital content transmitted to the display apparatus from a plurality of digital content associated with the category based on an initial value of a score representing user preference of the digital content.

6. The digital content display system according to claim 5,
wherein the update processing unit updates the score of the digital content based on the analysis result of the preference analysis unit, and when updating the summary information to be displayed in the predetermined order, updates and transmits summary information of digital content, for which the updated score exceeds a predetermined threshold value.

7. The digital content display system according to claim 5, further comprising:
a user identification number allocation unit which allocates a unique user identification number to each user when distributing the software; and
a score recording unit which records the updated score for each user identification number,
wherein the content acquisition unit treats a score recorded in the score recording unit as the initial value of the score of the digital content.

8. The digital content display system according to claim 3,
wherein the preference analysis unit analyzes user preference with at least one of the viewing time, the number of views, and the purchase history of the user as information relating to a viewing condition.

9. A digital content display method which displays digital content on a display apparatus of a user, the digital content display method causing a computer to implement:
a step of distributing software causing the display apparatus to display digital content in one of a plurality of categories and allowing the user to select a predetermined category or a predetermined digital content among a plurality of categories of digital content;
a step of receiving the category identification number of the selected category based on the software;
a step of acquiring a plurality of digital content belonging to the category of the received category identification number through a network;
a step of transmitting summary information of the plurality of acquired digital content and information for causing the software to display the summary information in a predetermined order to the display apparatus, and causing the display apparatus to display detailed information of a selected digital content according to selection information of digital content selected by the user from the summary information of the plurality of digital content; and
a step of acquiring viewing information representing a viewing condition of the user corresponding to at least one of the selected category, the transmitted summary information, and the transmitted detailed information, updating summary information of digital content to be displayed on the display apparatus in a predetermined order, and transmitting the updated summary information to the display apparatus.

10. A recording medium having recorded thereon a digital content display program, which displays digital content on a display apparatus of a user, the digital content display program causing a computer to implement:
a function of distributing software causing the display apparatus to display digital content in one of a plurality of categories and allowing the user to select a predetermined category or a predetermined digital content among a plurality of categories of digital content;
a function of receiving the category identification number of the selected category based on the software;
a function of acquiring a plurality of digital content belonging to the category of the received category identification number through a network;
a function of transmitting summary information of the plurality of acquired digital content and information for causing the software to display the summary information in a predetermined order to the display apparatus, and causing the display apparatus to display detailed information of a selected digital content according to selection information of digital content selected by the user from the summary information of the plurality of digital content; and
a function of acquiring viewing information representing a viewing condition of the user corresponding to at least one of the selected category, the transmitted summary information, and the transmitted detailed information, updating summary information of digital content to be displayed on the display apparatus in a predetermined order, and transmitting the updated summary information to the display apparatus.

11. The digital content display system according to claim 2, further comprising:
a preference analysis unit which analyzes user preference according to a viewing condition of the user for at least one of the category, the summary information, and the detailed information.

12. The digital content display system according to claim 2, further comprising:
a favorite management unit which displays digital content with a favorite tag attached by the user from the displayed digital content after update processing.

13. The digital content display system according to claim 3, further comprising:
a favorite management unit which displays digital content with a favorite tag attached by the user from the displayed digital content after update processing.

14. The digital content display system according to claim 4,
wherein the content acquisition unit selects digital content transmitted to the display apparatus from a plurality of digital content associated with the category based on an initial value of a score representing user preference of the digital content.

15. The digital content display system according to claim 6, further comprising:
a user identification number allocation unit which allocates a unique user identification number to each user when distributing the software; and
a score recording unit which records the updated score for each user identification number,
wherein the content acquisition unit treats a score recorded in the score recording unit as the initial value of the score of the digital content.
